(19) United States
(12) Patent Application Publication
(10) Pub. No.: US 2011/0254450 A1
(43) Pub. Date: Oct. 20, 2011

(54) PROCESS AND APPARATUS FOR REPLACING LEDs ON TRAFFIC SIGNS

(76) Inventors: Rick Bergholz, River Hills, WI (US); Brian Scharles, Mukwonago, WI (US); Jason Kugel, Milwaukee, WI (US); Dale G. Jones, Shell Beach, CA (US)

(21) Appl. No.: 13/073,442

(22) Filed: Mar. 28, 2011

Related U.S. Application Data
(60) Provisional application No. 61/341,342, filed on Mar. 29, 2010.

(51) Int. Cl. H05B 37/00; H01R 33/00; H05B 37/02

(52) U.S. Cl. 315/121; 315/294; 362/645

(57) ABSTRACT

A traffic sign having one or more easily replaceable LED assemblies that can easily be removed or replaced and that make reliable water resistant electrical connection with one or more suitably-designed LED holders, which are installed in various locations as desired on the traffic sign or structure, is disclosed. A control circuit that supplies direct current at suitable levels of DC voltage and DC current to the one or more LED holders that are connected together using series, parallel or combination series and parallel wiring connections in order to provide electrical power to the one or more LED assemblies is provided. Wherein the one or more LED holders also include compensation circuits that enable any failed LED assembly to be electrically bypassed so that the control circuit then automatically adjusts the DC current or DC voltage levels supplied to the remaining traffic sign LEDs so that the remaining LED Assemblies continue to operate properly.

### CROSS-REFERENCE TO RELATED APPLICATION

This is a regular utility application of provisional application Ser. No. 61/341,342, filed Mar. 29, 2010, the contents of which are expressly incorporated herein by reference.

### FIELD

Methods, systems and devices for allowing in-situ replacement of individual light emitting diodes (LEDs) mounted on traffic signs or structures and which are used to provide enhanced visibility and/or improved awareness by oncoming drivers of motor vehicles are discussed herein.

### BACKGROUND

Aspects of the present methods, systems, and apparatus are useful for replacing burned out LEDs mounted on traffic signs or similar structures used for increasing the visibility of such signs or structures when viewed by oncoming motor vehicles. Prior art patents directed to illuminated traffic signs using LEDs are disclosed in U.S. Pat. Nos. 6,693,556 and 6,943.698 and in pending application Ser. No. 12/140,871, filed Jun. 17, 2008, which have been issued, invented, or developed by one or more of the co-inventors listed with respect to the present application, the contents of each of which are expressly incorporated herein by reference for all purposes. Additional background information regarding use of LEDs can be found in provisional application Ser. No. 61/342,379, filed Apr. 12, 2010, which is junior to the provisional application to which this application depends. The contents of the '379 application are expressly incorporated herein by referenced.

The referenced patents and pending application relate to traffic signs with individual LEDs mounted at discrete points around the periphery of the traffic sign face. This location for the position of the LEDs provides significantly-increased visibility as observed by oncoming motor vehicle traffic, and also reduces the electric power required for the LEDs to produce a high degree of improved traffic sign visibility. These beneficial effects provide both reduced costs as well as a significant improvement in practical applications. However, one problem that has faced these types of LED traffic signs in the past is the maintenance difficulty encountered during replacement of one or more LEDs which have burned out or failed. Such LED replacement presently requires removing the LED sign and either replacing it with a new LED sign, or replacing the failed LED in a clean indoor setting such as the traffic sign shop, and then replacing the repaired LED traffic sign on the original mounting structure. This type of maintenance is not only time consuming and labor intensive, but additional expenses are typically incurred for costs incurred for shipping LED components and/or LED traffic signs back and forth.

### SUMMARY

The present methods, systems, and apparatus make use of several optional LED Assemblies that allow any failed LED to be removed and replaced in situ under normal highway maintenance procedures, without having to remove the LED traffic sign from the mounting structure. In some examples, these LED Assemblies fit into LED housing(s) which are permanently mounted onto the traffic sign. Such LED Assemblies can be installed or removed as desired using simple hand operated tools. Several optional types of LED Assemblies with various types of electrical connections methods, including spring-loaded contacts (coil vs. leaf springs, etc.) or pin-type connections (dual pins vs. bayonet pins, etc.) may be used. In addition, any type of LED wiring connections, either parallel connections, series connections and/or combination of both parallel and series connections, may be used. In the event that one or more of the remaining LEDs has failed, a miniaturized compensation circuit mounted inside the LED housing to enable all of the remaining traffic sign LEDs to continue operating normally may be incorporated.

Light-emitting diodes, or LEDs, are ever increasingly popular means for providing illumination in such widely varied applications as traffic signs, automobile brake lights, traffic signals, hand-held electronic devices and electronic message boards. LEDs provide illumination with an electrical energy saving typically more than 90% compared with conventional incandescent light bulbs. LEDs also have an operating lifetime typically more than about 10 years. LEDs typically operate at direct current (DC) voltages which depend on the color of the LED and the forward voltage rating of the LED. For example, red and yellow LEDs typically operate at about 3.2 to 3.4 VDC and white LEDs typically operate at about 4.1 to 4.3 VDC.

To enhance the usefulness of LEDs for the purpose of increasing the visibility of traffic signs, means for controlling the current supplied to one or more LEDs from a variety of different types of power supply sources is a factor to consider. For example, LEDs cannot be adequately controlled simply by providing a constant DC supply voltage. One reason is that in most cases, each LED differs from the other LEDs because each LED is ranked according to its specific forward voltage parameter. The forward voltages of typical LEDs can vary by +/−20% or more. If the forward voltage of an LED is exceeded by as little as +5%, as one specific example, the LED can quickly burn out because the current through the LED would then increase in a non-linear fashion as forward voltage is increased only slightly.

Power supply sources considered herein include batteries, such as rechargeable batteries which can be recharged using solar photovoltaic panels, external sources of electric power derived from the electricity grid (typically 120VAC or 240VAC) or from external generators, or fuel cells, such as micro fuel cells using the direct methanol fuel cell (DMFC) process. Fuel cells can typically be recharged using methanol or other alcohol mixtures. Solar photovoltaic panels typically utilize crystalline silicon cells connected in series to obtain sufficiently high voltages for efficient charging of rechargeable storage batteries. Electric energy is then withdrawn from the rechargeable storage batteries by a control circuit to provide electrical power for properly operating the one or more LEDs.

The power supply system that is to be used to provide proper operation of one or more LEDs mounted on a traffic sign or structure typically depends on the type of LEDs as well as the electrical wiring connections between the LEDs and the Control Circuit used to regulate current and voltage from the power system to the LED network on the traffic sign. The LEDs may be electrically connected in parallel, in series, or in a combination of both parallel and series. As previously mentioned. LEDs cannot be properly operated simply by supplying a fixed DC voltage. The DC current supplied to one or more LEDs should be properly controlled to avoid burning out the LEDs if the current is too high, but also to provide adequate current to the LEDs (to assure adequate light output from the LEDs) over a reasonably wide range of power supply voltages. For example, if one or more LEDs are to be operated from a fixed battery system, the battery voltage will decrease as the LEDs continue to be operated. In one preferred embodiment, the battery system consists of a rechargeable battery suitably connected to a solar photovoltaic panel, which recharges the battery during the daytime when there is adequate ambient light intensity. At night or in dim ambient lighting conditions, the battery system is then also used to operate one or more LEDs as desired.

In another preferred embodiment, a photocell sensor is used to detect the night or dim ambient lighting conditions and subsequently turn on the one or more LEDs. Other types of sensors could optionally be used to provide on-off control of the LEDs, such as photodiodes, phototransistors, photothyristors and light-activated silicon-controlled rectifiers (LASCRs). A Control Circuit is located between the battery system and the LEDs. The Control Circuit regulates the voltage and the current provided to the one or more LEDs to insure proper operation of the LEDs over a relatively wide range of battery supply voltages. The same type of Control Circuit can be used if the power supply system consists of a DMFC micro fuel cell or an externally-supplied source of electrical energy (such as 120VAC or 240VAC), rather than a battery which can be recharged during daylight hours using a solar photovoltaic panel.

Aspects of the present methods, systems, and apparatus for allowing in-situ replacement of individual light emitting diodes (LEDs) mounted on traffic signs or structures and which are used to provide enhanced visibility and/or improved awareness by oncoming drivers of motor vehicles. The LEDs themselves (or the reflected light patterns coming from the LEDs) are generally aimed towards the oncoming traffic. The LEDs are generally mounted around the periphery of the traffic sign or structure, mounted so as to illuminate at least one face of the traffic sign or structure, or mounted in a pattern on the traffic sign or signal to provide distinctive indicia with the purpose of increasing the visibility of the traffic sign or structure as viewed by oncoming traffic, among others. The LEDs can blink on and off or the LEDs can be steadily illuminated. The LEDs can also be used to illuminate or to highlight the appearance of at least one face of the traffic sign or structure.

Light emitting diodes, or LEDs, operate in a manner similar to conventional light bulbs. Just like conventional light bulbs, any individual LED operates only for a specific length of time before burning out. When an LED burns out on a traffic sign, the necessary repair by the highway maintenance department has not been simple. In the past, it has been required to remove the LED traffic sign from the mounting structure and replace it with another LED traffic sign. An alternative approach has been to remove the LED traffic sign, move it to a shop then remove the failed LED while working in the traffic sign shop, then remove and replace the failed LED with a new LED, and finally replace the repaired LED traffic sign by moving it back to the operating site and attaching it onto the mounting structure.

The present methods, systems, and apparatus are useful for replacing any LED mounted on a traffic sign which might have failed without requiring that the LED traffic sign be removed from the mounting structure. The present methods, systems, and apparatus include several alternative removable LED assemblies that fit into one or more LED holders installed on the traffic sign, thereby minimizing the time and effort required for replacing failed LEDs in situ. Another feature of the present methods, systems, and apparatus include a provision for using only hand operated tools and doing the required LED replacement under normal highway maintenance procedures.

LED traffic signs may be powered from solar rechargeable batteries or external sources of electric power, such as 120VAC or 240VAC. The traffic sign LEDs themselves can be connected in series or in parallel or in a combination of series and parallel. In the event that one or more LEDs on the traffic sign burns out, the present methods are provided for maintaining correct operation of all the remaining LEDs which have not burned out, regardless of the source of electric power or the method used for wiring connections between the LED housings to provide power to the LEDs.

Aspects of the present methods, systems, and devices include two (2) distinct elements—(Element 1): One or more replaceable LED Assemblies which can be easily removed or replaced (and are suitable for in situ repair or replacement provided by normal highway maintenance personnel using hand operated tools) and which make reliable and water resistant electrical connection with one or more suitably-designed LED holders which are installed in various locations as desired on the traffic sign or structure, and (Element 2): A Control Circuit which supplies direct current at suitable levels of DC voltage and DC current to the one or more LED holders which are connected together using series, parallel or combination series and parallel wiring connections in order to provide electrical power to the one or more LED Assemblies, wherein the one or more LED holders also include compensation circuits which enable any failed LED assembly to be electrically bypassed so that the Control Circuit then automatically adjusts the DC current or DC voltage levels supplied to the remaining traffic sign LEDs so that the remaining LED Assemblies continue to operate properly.

By combining these two (2) elements, the present methods, systems, and devices provide replaceable LED Assemblies installed into LED holders on the traffic sign which have the same color light and appear to operate at the same overall light output brightness level, regardless of the forward voltage (Vf) rating of the LEDs or the source of the electric power supply. The equality of the apparent LED light output brightness levels for such traffic sign LEDs is based on the ability of the Control Circuit combined with the compensation circuits to avoid over-driving or under-driving the LEDs. Electrical power may be supplied to the Control Circuit from external power sources (120VAC or 240VAC) or from a rechargeable battery which may be recharged using solar photovoltaic panels or from other types of power sources such as fuel cell systems recharged by adding chemicals to the fuel cell.

By installing small-sized compensation circuits inside the LED holders, most if not all type of LED traffic signs can operate reliably regardless if one or more of the LEDs has burned out. If any particular LED mounted on a traffic sign happens to fail, it can be replaced with the same color LED without the maintenance personnel having to worry about the forward voltage (Vf) value of the LED. Also, the maintenance personnel can replace the same color of LED into a series-connected LED holder socket or a parallel-connected LED holder socket without knowing which type of socket connection wiring has been used for the specific LED traffic sign. Regardless of which type of socket wiring connection has been used, the present invention allows the replaced LED to work perfectly and match with the apparent brightness of all the other LEDs which have not yet burned out.

Another aspect of the present assembly and system includes a lighting sub-assembly comprising an LED holder having a cavity: an LED assembly positioned in the cavity in a water-tight seal with a housing of the LED holder; a circuit board located inside the housing and below the LED assembly; at least one coil spring located between the circuit board and the LED assembly for electrically coupling the circuit board and the LED assembly: and wherein the LED assembly is rotatable relative to the housing to change a light beam spread orientation of light emitted from the lighting sub-assembly.

### BRIEF DESCRIPTION OF THE DRAWINGS

The various embodiments of the present methods, systems, and devices will now be discussed in detail with an emphasis on highlighting the advantageous features. These embodiments depict the novel and non-obvious apparatus shown in the accompanying drawings, which are for illustrative purposes only. These drawings include the following figures, in which like numerals indicate like parts:

FIG. 1 is a perspective cut-away view of an LED holder and LED assembly:

FIG. 2 is an exploded view of the LED holder & LED assembly of FIG. 1;

FIG. 3 is a sectional view of the LED holder and LED assembly of FIG. 1;

FIG. 4 is a partial exploded view of several main parts of an LED mounting system;

FIG. 5 shows ring slots for lens angle adjustment;

FIG. 6 is a perspective view of an LED keyway and lens adjustment teeth of FIG. 5;

FIG. 7 shows exemplary dimensions of one specific LED mounting system;

FIG. 8 is a schematic view of a 40×20 degree lens illumination spread;

FIGS. 9a and 9b show different sectional views of a threaded bezel ring with tapered O.D.;

FIGS. 10a and 10b show different sign mounting views of the threaded bezel of FIGS. 9a/9b with O.D. taper;

FIGS. 11a-11c show different LED assembly and section views of a threaded bezel with O.D. taper;

FIG. 12 shows a perspective sectional view of an O-ring-base enclosure for retaining an LED assembly;

FIG. 13 is a cross-sectional view of the enclosure of FIG. 12 of an O-ring-based enclosure of LED assembly and LED holder;

FIG. 14 is a partial explode side view of an LED assembly and LED holder:

FIG. 15 is a side view of an LED assembly partially inserted into an LED holder;

FIG. 16 is a block diagram of a PWM control circuit;

FIG. 17 is a PWM control circuit for LEDs;

FIG. 18 is an LED holder compensation circuit with OpAmp; and

FIG. 19 is a transistorized LED holder compensation circuit.

### DETAILED DESCRIPTION

The detailed description set forth below in connection with the appended drawings is intended as a description of the presently preferred embodiments of traffic signs with LED lights and assemblies, such as LED light sub-assemblies that are capable of replacing and/or repairing in-situ, provided in accordance with aspects of the present device, system, and method and are not intended to represent the only forms in which the present device, system, and method may be constructed or utilized. The description sets forth the features and the steps for constructing and using the traffic signs with LED lights and assemblies of the present device, system, and method in connection with the illustrated embodiments. It is to be understood, however, that the same or equivalent functions and structures may be accomplished by different embodiments that are also intended to be encompassed within the spirit and scope of the present device, system, and method. As denoted elsewhere herein, like element numbers are intended to indicate like or similar elements.

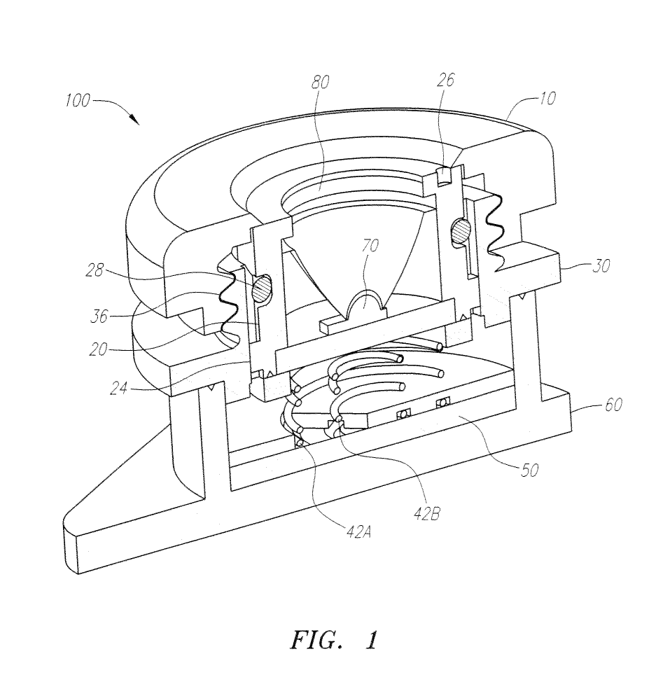

FIGS. 1 through 11 show various components of one or more LED (light emitting diode) holders 30 for mounting on a traffic sign or structure, such as a traffic sign having a structure. As further discussed below, these LED holders 30 utilize a removable threaded bezel ring which can be removed or replaced as desired using hand operated tools to exchange or replace any of the one or more LED assemblies.

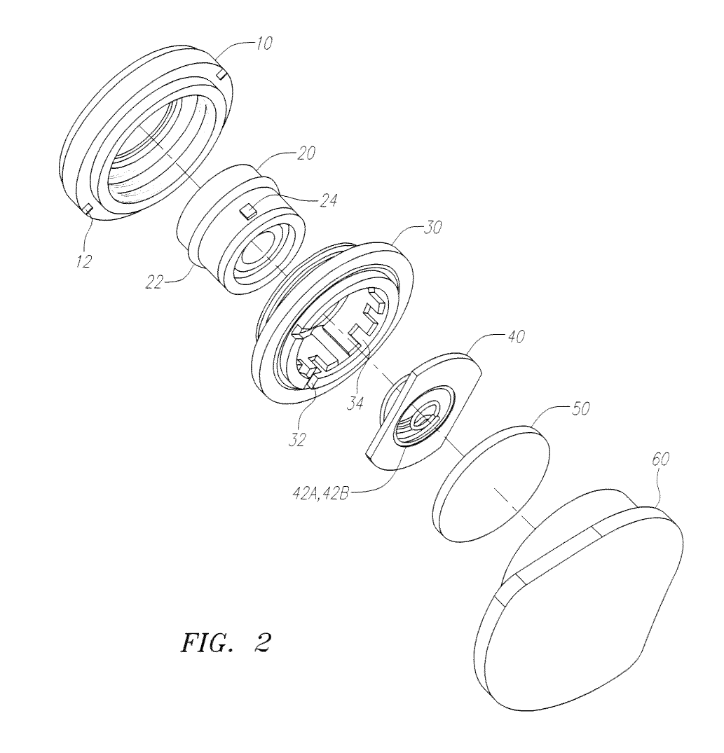

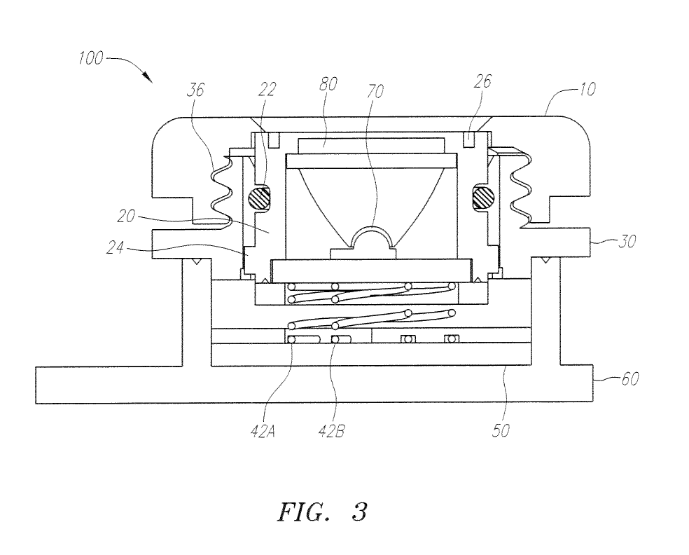

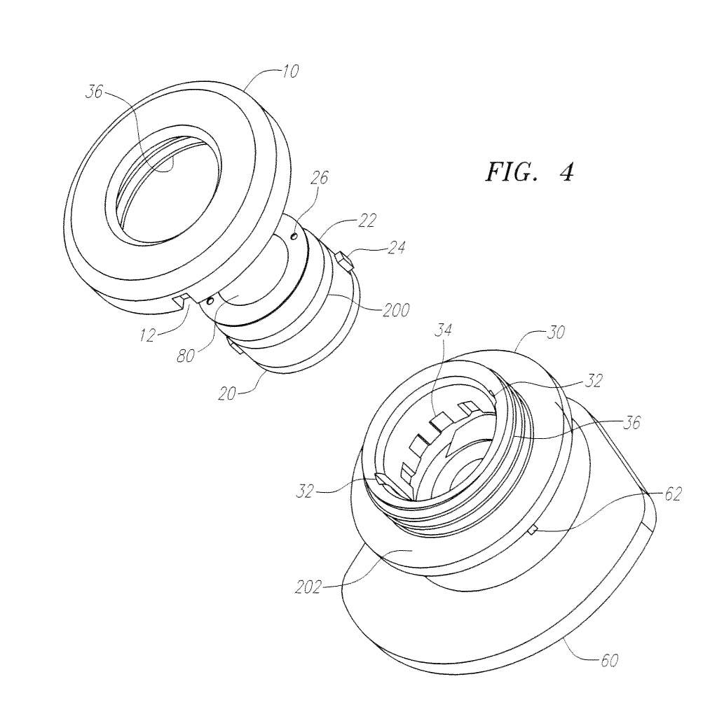

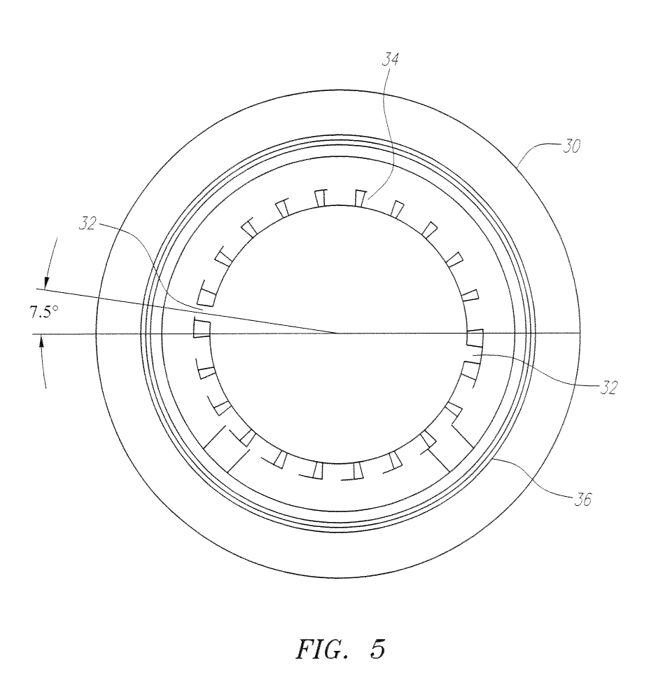

FIG. 1 shows a cross-sectional perspective view of an LED assembly 20 installed into an LED holder 30. FIG. 2 is a corresponding exploded view showing various parts of the assembly of FIG. 1. The completed assembly showing a half-cross section is shown in FIG. 3 and the various components just prior to installation of the LED assembly 20 into the LED holder 30 is shown in FIG. 4. Details of the LED holder 30 as well as exemplary dimensions of the various components or parts are shown in FIGS. 5, 6 and 7.

Turning first to FIG. 4, the LED assembly 20 includes a compressible O-ring 22 mounted in an external groove 200 on the cylindrical LED assembly. When the LED assembly 20 is installed into the housing 202 of the LED holder 30, the O-ring 22 is compressed between the two cylindrical surfaces to thereby provide a water resistant seal between the LED assembly 20 and the LED holder 30. The LED assembly 20 also includes external exposed tabs 24, which are used to guide the installation into the LED holder 30 through the keyway slots 32 in the LED holder 30. The LED holder 30 also includes click stop grooves 34 arranged around the periphery of the interior surface of the housing 202, which are used for adjusting the rotation angle of the LED assembly 20. For example, the external exposed tabs 24 can engage with the click stop grooves 34 when the LED assembly 20 is released and the coil compression springs 42A and 42B push the LED assembly 20 upwards into a locked position inside the LED holder 30. Rotation pin holes 26 in the top exposed circumference of the LED assembly 20 may be incorporated, which are configured for mating a hand operated tool (not shown), to engage the rotation pin holes 26 so that the LED assembly 20 can be pushed downwards further into the LED holder 30 against a biasing force of a spring and rotated so as to engage the click stop grooves 34 at the desired rotation angle. Alternatively, the pin holes 26 and the tool may engage for rotating the tabs 24 into alignment with the keyway slots 32 so as to remove the LED assembly 20. As shown, a gap is provided between a bottom of the LED assembly 20 and the compensation circuit 50.

FIG. 4 also shows enclosure shell 60 on the LED holder assembly 30 and one or more electrical wire openings 62 used for providing electrical power connections to the LED holder 30. In one example, the LED holder 30 is permanently installed into a suitable structure, such as a hole, a recessed space, or a slot, located in or on the traffic sign at a desired location on the sign. The LED holder installation is completed by screwing down threaded portion of the threaded bezel ring 10 over the threaded portion 36 of the housing 202 to mechanically squeeze the traffic sign material between the threaded bezel ring 10 and the LED holder 30. The two threaded portions 36 are sufficiently detailed to allow the installation of the LED holder 30 into different thicknesses of traffic signs, typically ranging between a minimum of about 0.060 inches to a maximum of about 0.125 inches. However, by providing a sufficiently long threaded portion on the bezel ring 10 or the housing 202 or both, installations on other thickness range are possible. The threaded bezel ring 10 is tightened during installation using a hand operated tool, which engages one or more external notches 12 used to install or remove the threaded bezel ring 10. In another embodiment, bayonet-type lock is used instead of threads. However, clamps, threads, locking collars, and various known prior art locking arrangements may be used without deviating from the instant assembly.

Turning now to FIGS. 1 and 2, additional internal details of the lighting sub-assembly 100 are shown. For example, the compressible O-ring 22 is shown in its final position where it provides a water resistant seal between the cylindrical surfaces of the LED assembly 20 and the LED holder 30. Also shown in these figures are two compressible coil springs 42A and 42B, which provide a secure electrical connection between the LED assembly 20 and the compensation circuit 50, which is provided with the input and output electrical wiring connections that penetrate through the enclosure shell 60. The compensation circuit 50 will be discussed in further detail below, which can provide an electrical bypass around the LED assembly 20 in the event the LED assembly 20 ever fails. The compression coil springs 42A and 42B act to push the LED assembly 20 upwards inside the LED holder 30 so as to engage the external exposed tabs 24 into the click stop grooves 34 at the desired rotation angle of the LED assembly 20, as previously discussed with reference to FIG. 4. FIGS. 1 and 3 also show the LED itself 70 and the collimating lens 80 housed over the LED 70 and securely mounted inside the LED assembly 20. In other embodiments, a single coil spring or more than two coil springs are used. Less preferred, an elastomeric compressible material is used to provide the biasing force. For the alternative biasing means, different wire arrangements may be made instead of through the coil springs, as will be apparent from the discussions below. In one example, the springs provide duo-means for the lighting sub-assembly 100, which includes biasing the LED assembly against the bezel ring 10 and providing electrical connections between the LED assembly and the compensation circuit.

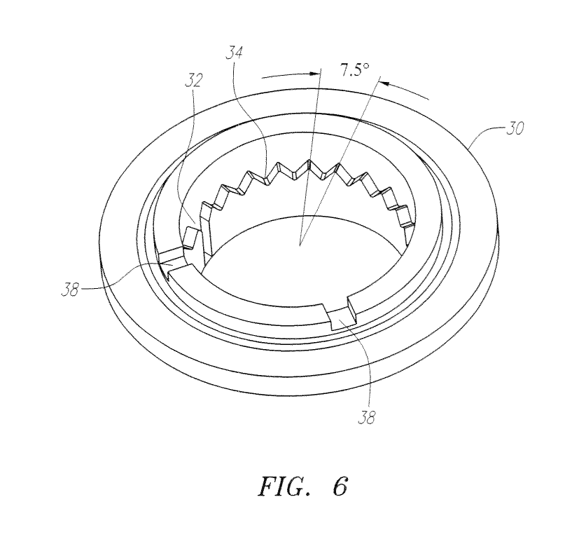

FIG. 5 shows additional details of the LED holder 30 with the keyway slots 32, click stop grooves 34, and threaded portion 36. The click stop grooves 34 are positioned around the inside periphery of the LED holder 30 at distances which are spaced apart by an angle of about 7.5 degrees. A bottom view of the LED holder 30 is shown in FIG. 6, where electrical wire slots 38 are also shown, along with the click stop grooves 34 and the keyway slots 32 included in the design of the LED holder 30. For a more accurate fine tuning of the angle of rotation of the LED assembly 20, or more coarse tuning of the LED assembly 20, to the LED holder 30, the angular spacing and the size of the external tabs 24 may be increased or decreased.

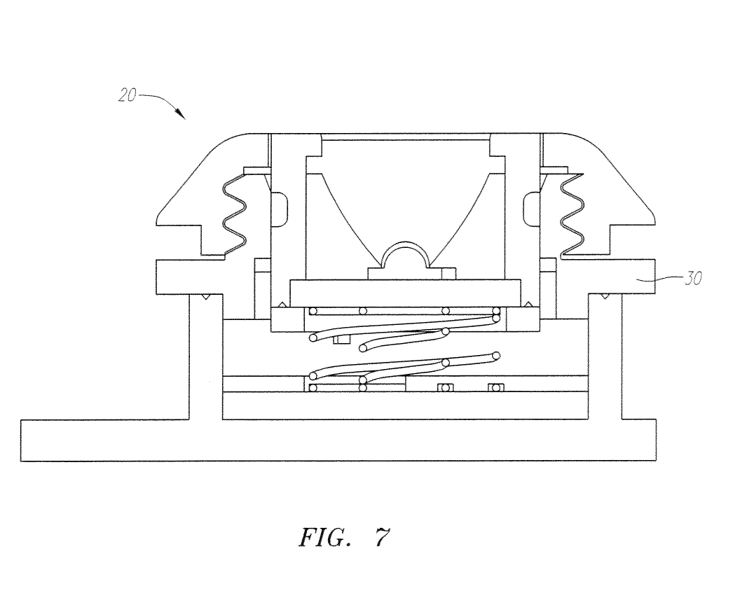

FIG. 7 provides a partial cross-sectional drawing of the LED assembly 20 mounted inside the LED holder 30 along with typical dimensions expressed in millimeters. It is obvious that different dimensions could be used as well as different arrangements of the assembled components. As such. FIGS. 1 through 7 are provided to illustrate an exemplary embodiment of the present method, device and assembly only and not intended to be delimiting.

Returning specifically again to FIGS. 2 and 3, the LED assembly 20 includes an external O-ring 22, which provides water resistance and prevents water intrusion when the LED assembly 20 is pushed into the LED holder 30 thereby compressing the O-ring 22 between the piston and the cylinder of the assembly itself. The LED assembly 20 includes the LED 70, a collimating lens 80 used for providing a narrowly-focused output light beam, bottom-mounted electrical contacts as well as exposed external tabs 24, which guide the LED assembly 20 during installation and are also used for positioning the depth and the angle of rotation of the LED assembly 20 as desired inside the LED holder 30.

The LED holder 30 is shown in exploded views in FIG. 2, including two coil compression springs 42A and 4211 which are mounted on the spring assembly or housing 40, the compensation circuit 50, and the enclosure shell 60. As shown in FIG. 3, when the LED holder 30 is assembled and forms a lighting sub-assembly 100, it can then be installed into a suitable hole in a traffic sign, such as a traffic sign structure, and secured in place by tightening the threaded bezel ring 10 using a hand operated tool. The basic elements of this assembly are shown in FIG. 4 with the threaded bezel ring 10 separated from the LED assembly 20 and with the LED holder 30 also separated to show how the components are put together. The LED assembly 20 is pushed into the LED holder 30 and the spring assembly 40 is compressed, thereby making suitable electrical contact connections with the electrical wires which pass through the electrical wire openings 62 provided through the enclosure shell 60.

The electrical wires connecting all the various LED holders 30 together on the LED traffic sign can be arranged to provide series-connected LEDs, parallel-connected LEDs, or a combination of both series and parallel-connected LEDs. There can be a single LED holder 30 with a single LED assembly 20 on a traffic sign or more than one combination LED holder 30 and LED assembly 20 on a traffic sign, such as two, three, or more than three, such as eight or ten. For series-connected LED holders 30, the spring assembly 40 provides two coil springs 42A and 42B. One coil spring 42A connects the input electrical wire from the compensation circuit 50 to the appropriate electrical input located on the bottom of the LED assembly 20. The other coil spring 42B connects the electrical output from bottom of the LED assembly 20 to the compensation circuit 50, which is also connected to the output electrical wire. For parallel-connected LEDs, the positive and negative wires coming into the LED holder 30 are both connected to the compensation circuit 50, which then makes connection with the electrical contacts on the bottom of the LED assembly 20 by means of the spring assembly 40. These same parallel-connected electrical wires are then passed onward to the next LED holder 30.

It should be noted that there are many different types of electrical contacts which can be used between the LED assembly 20 and the LED holder 30. For example. FIGS. 1 through 4 illustrate the use of twin coil compression springs 42A and 42B housed in a spring assembly 40. However, instead of coil-type compression springs, other types of springs could be used, such as leaf springs. Leaf springs could also be combined with bi-pin connectors that engage with appropriate socket slots in the bottom of the LED holder 30 and make contact with leaf springs located below these socket slots. This is similar to the method used for electrical connection of the common type of GU, 10 twist and lock ceramic sockets which are used with MR16 halogen lamps and 120VAC PAR halogen spotlights. There are a wide variety of various types of bayonet twist and lock socket designs that could also be used for connected the LED assembly 20 to the LED holder 30. In addition, there are many alternative types of socket connections which could be used, including bayonet button type, screw type, wedge type or hi-pin twist and lock type electrical connector contacts.

As previously noted, the LED assembly 20 makes use of exposed external tabs 24 for the purposes of installing the LED to the correct depth as well as allowing the LED assembly 20 to be rotated to the desired angle for the collimating lens 80. The LED assembly 20 can be installed or removed using a simple hand operated tool for engaging the double pin holes 26 on the outer circumference of the LED assembly 20. When the LED assembly 20 is pushed into the LED holder 30, the external O-ring 22 is compressed. This prevents water intrusion inside the LED holder 30. It is also acceptable to utilize one or more flexible gaskets which are compressed when the LED assembly 20 is installed into the LED holder 30 and water resistance is provided when the one or more flexible gaskets are compressed during installation.

The light emitting diodes, or LEDs, being utilized most commonly for the LED traffic signs are generally the Luxeon Star type which are rated 1 watt, but also come in 3 watt and 5 watt varieties. The 1 watt Luxeon Star version is preferred as it has been found to provide sufficient lighting and appropriate power consumption. The red and yellow colored Luxeon Star 1 watt LEDs normally are rated at about 3.3VDC and about 300 mA, with a light bean output angle typically very wide at about 120 degrees.

In order to provide a more intense LED output light, collimating lenses are typically used. For example, the Luxeon NX05 collimating lens fits right over the 1 watt Luxeon Star LED and causes the light output angle to be reduced from about 120 degrees down to about 30 degrees. Such a narrow light beam output from the LED offers several advantages, including less electrical power required for high visibility, less wide angle light seen from the side, which would normally interfere with cross-street traffic and/or residential housing, and much more highly effective ability to aim the light beam towards oncoming traffic. Less preferred, the lighting sub-assembly 100 is used without a collimating lens.

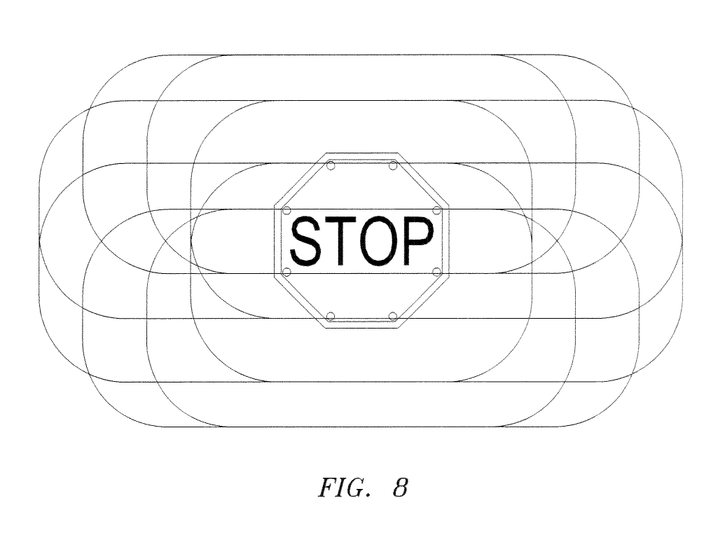

For LED traffic sign installation locations with wide street intersections, the output LED light beam should be wider than 30 degrees in the horizontal direction to provide improved visibility for oncoming traffic. The increase in horizontal light beam width does not mean that the light beam also needs to be wider in the vertical direction but optionally can. Other types of collimating lenses have been developed to meet this requirement. For example, the Frean FLP 40×20 collimating lens provides a horizontal output light beam with angle of about 40 degrees, while the vertical light beam output is restricted to about 20 degrees. FIG. 8 shows an example of how eight (8) 1 watt red-colored Luxeon LEDs will project the output light beams from an octagonal R1-1 STOP sign when using the Frean FLS 40×20 collimating lenses. In FIG. 8, the light beam spread in the horizontal direction is at nearly twice as wide as the light beam spread in the vertical direction.

The increased width of the output light beam in the horizontal direction is accomplished by adjusting the installation angle of the LED assembly 20 for each of the eight (8) individual LEDs to align all the output light beams with the 40-degree spread positioned in the horizontal direction and the 20-degree spread positioned in the vertical direction. This involves having a number of adjustment teeth molded into the LED holder 30 so the LED assembly 20 can be rotated as desired into adjacent teeth 34, which are positioned as shown in FIGS. 5 and 6 at 7.5-degree intervals. In other embodiments, the out it beams are randomly adjusted or adjusted to have equal horizontal spread as vertical spread. There are also key-way slots 32 at opposite locations along the inside diameter of the LED holder 30. The two (2) exposed external tabs 24 located on the LED assembly 20 are used for guiding the installation process as these tabs 24 slide downwards through the two (2) keyway slots 32 when the LED assembly 20 is being pushed into the LED holder 30. Once the LED assembly 20 has been pushed all the way down, it can then be rotated to the desired light beam output angle and released. The coil compression springs 42A and 42B then push the LED assembly 20 upwards so that the exposed external tabs 24 engage the angle adjustment teeth 34 to complete the installation of the LED assembly 20. In other embodiments, the LED assembly 20 is held stationary while the LED holder 30 and collimating lens 80 are rotated to provide a desired light spread.

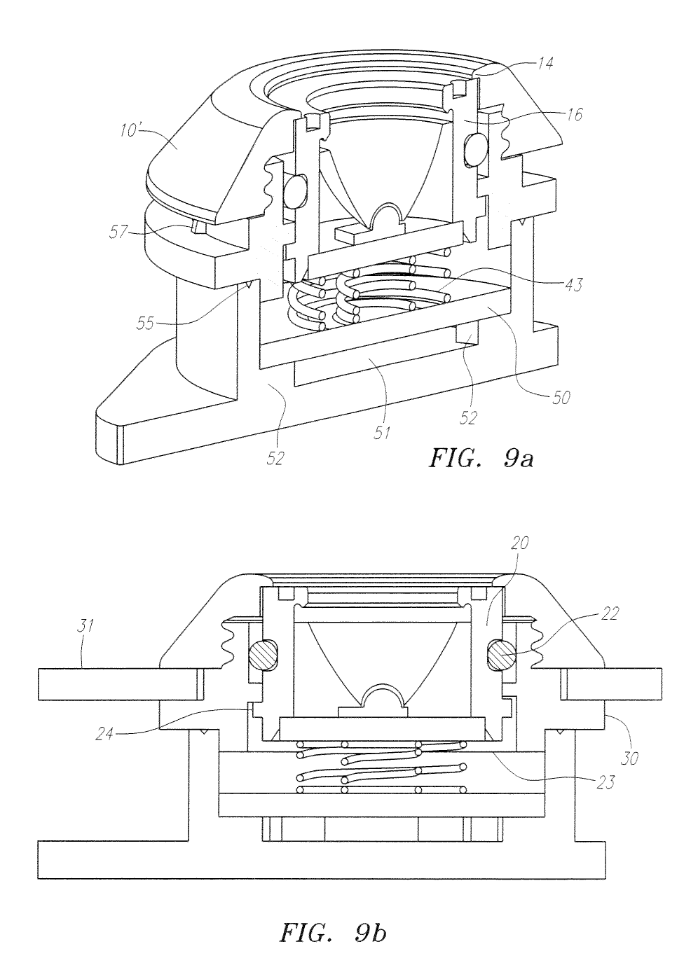

FIGS. 9a-9b, 10a-10b and 11a-11e provide cross-sectional and perspective views of threaded bezel ring 10′ that has a tapered O.D. to provide a more uniform exterior and more vandalism-proof external appearance when mounted on traffic signs or structures. The tapered O.D. of the threaded bezel ring 10 requires a hand operated tool for installation or removal to insure that the threads are sufficiently tight to prevent undesirable loosening. Such hand operated tools can include bi-pin tools or similar types of hand tools to fit impressions or holes in the O.D. of the tapered bezel ring 10′ and/or the LED assembly 20.

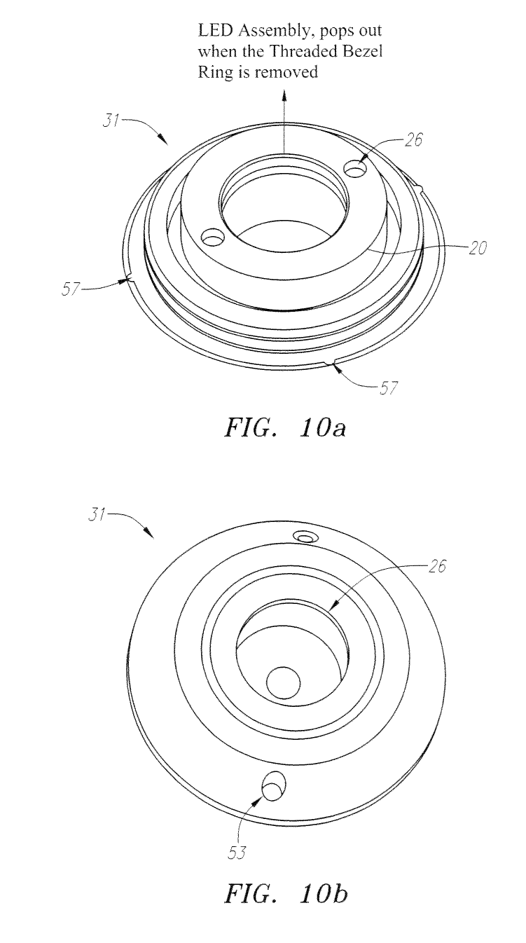

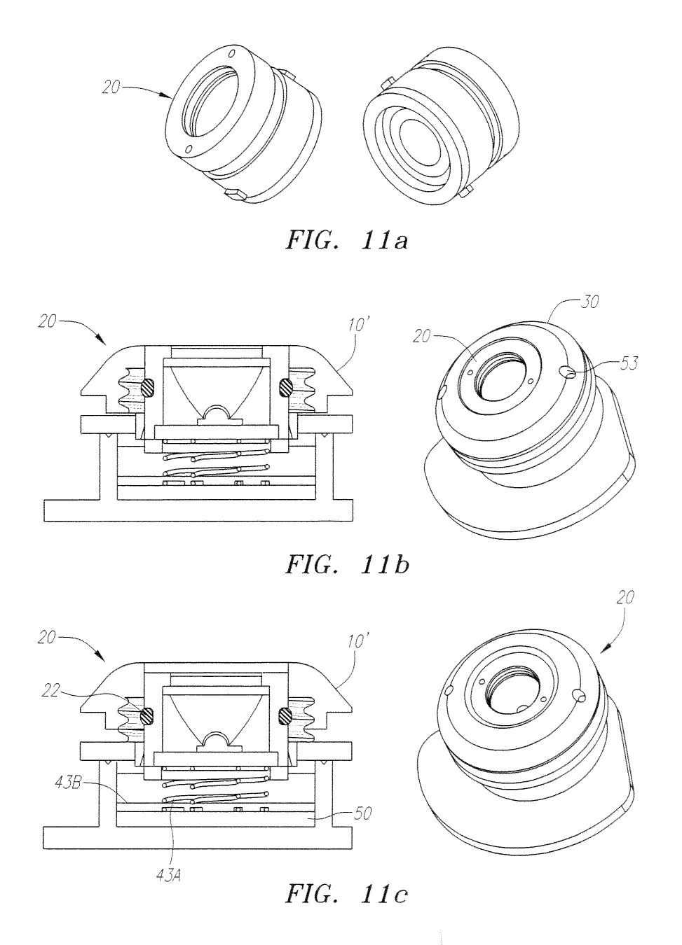

The additional views shown in FIGS. 9a-9b, 10a-10b and 11a-11c provide details about the optional threaded bezel ring 10′ with tapered external face and/or side, when viewed in cross-section. As shown in FIGS. 10a-10b, the LED assembly 20 pushes upwards when the threaded bezel ring 10′ is unscrewed, using a bi-pin tool that allows the tapered bezel ring to be tightened or unscrewed via external holes 53 (FIG. 11c). The O-ring 22 provides a waterproof seal between the removable LED assembly 20 and the LED holder 30, which is securely mounted into or onto a traffic sign 31, for example on a frame of a yield or stop sign by inserting into a receiving hole or opening on the sign. Optional radial ribs or projections 57 can be added to the periphery of the LED holder 30 to insure that the LED holder 30 is secured inside the I.D. of the traffic sign 31 mounting hole, such as to prevent rotation relative to the mounting hole. The LED assembly 20 also has twin holes 26 that are used with another bi-pin tool so that the angle of the LED assembly 20 can be adjusted as desired using the radial tabs 24 on the sides of the LED assembly 20 as has been previously described. Also shown in FIGS. 9a-9b and 10a-10b are the PCB 50 with cavity 51 underneath to allow space for PCB components used for the compensating circuit, which will be described below. Standoff supports 52 are provided on the LED holder 30 to support the PCB 50. Also shown is a LED holder part detail 55, which is an ultrasonic energy deflector used to assist bonding the plastic parts together during high speed, high frequency ultrasonic welding assembly. FIGS. 11a-11c provide additional views of the removable threaded bezel ring 10″ with tapered O.D. and sectional views of the LED assembly 20 and the LED holder 30. Also shown are the electrical contacts 43A for the compressions springs 42A and 42B, which are mounted by soldering onto the plastic spring assembly 43B. Not shown in FIG. 11 are the electrical ring contacts located on the underside of the LED assembly 20 that provide the DC voltage needed for proper operation of the LED.

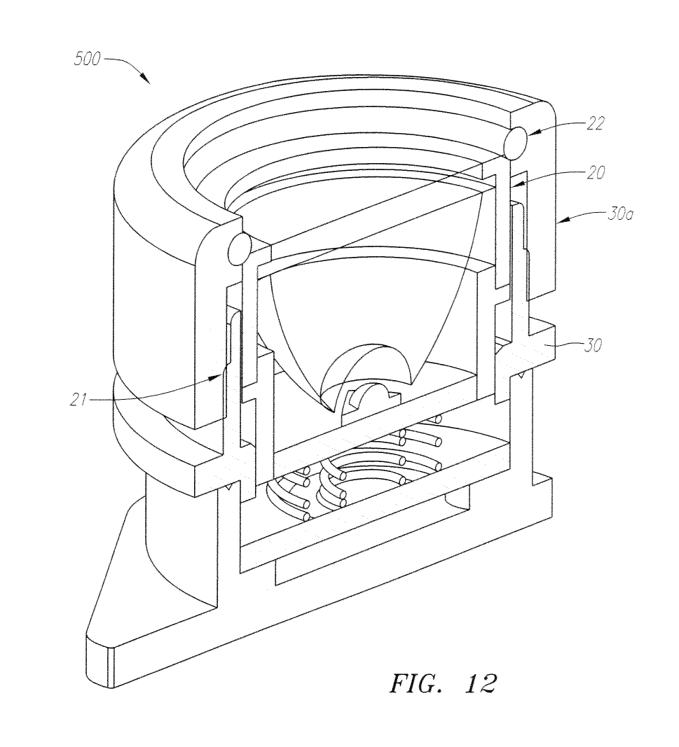

FIGS. 12 through 15 show an alternative lighting sub-assembly 500 with similar parts as previously shown and described except that the O-ring 22 has been moved upwards within the lighting sub-assembly 500 relative to the similar lighting sub-assembly 100 shown in FIG. 3, as an example. The LED holder 30 in the present example utilizes a removable flexible O-ring 22, which can be removed or replaced as desired using hand operated tools to exchange or replace any of the one or more LED assemblies 20.

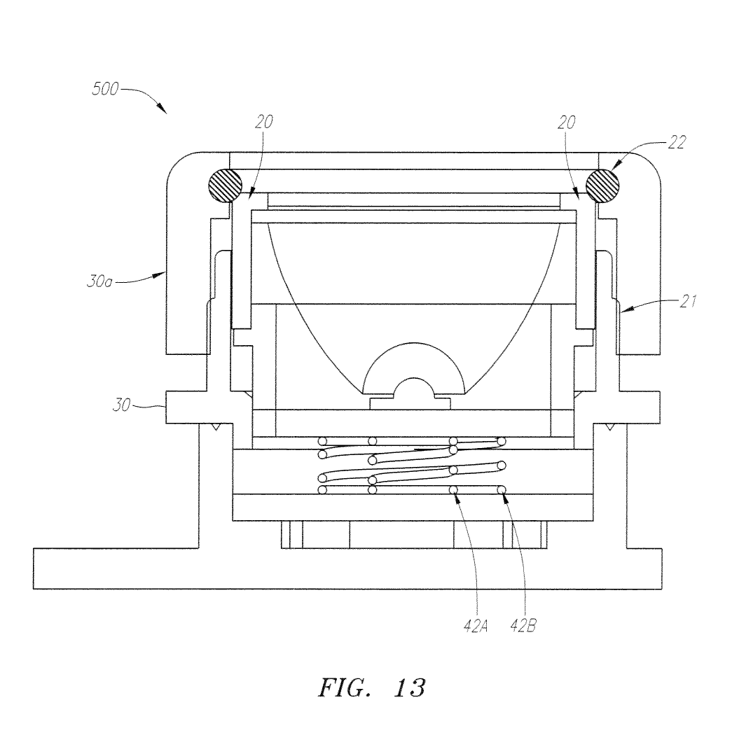

As shown in the cross-section perspective view in FIG. 12, an LED assembly 20 is installed into the LED holder 30 and the flexible O-ring 22 is manually installed into the I.D. groove 206 along the inside top surface of the outside LED holder assembly 30a, which is configured to be permanently mounted onto a traffic sign or structure using acoustic welding methods at high ultrasonic frequencies to weld the plastic parts together as shown by the interference tolerance fit 21 (FIG. 13) between the two (2) LED holder parts. No un-threading or removing of a removable bezel is utilized with the instant lighting sub-assembly. The interference tolerance fit 21 is shown in FIGS. 12, 13, 14 and 15. FIG. 13 shows a side cross-section view of the complete assembly with the flexible O-ring 22 being squeezed by the upward force from the two (2) electrical compression springs 42A and 42B at the bottom, which force the LED assembly 20 upward against the flexible O-ring 22 and compressing it slightly to cause a waterproof O-ring seal between the movable and cylindrical LED assembly part 20 and the fixed LED housing part 30. The LED assembly 20 can be cylindrical or any other type of optional shaped part, but the cylindrical shape allows the LED assembly 20 to be easily rotated to any desired angle to enable the LED light output to be focused as desired if special types of output collimating lenses are used, as was previously described above and as shown in FIG. 8.

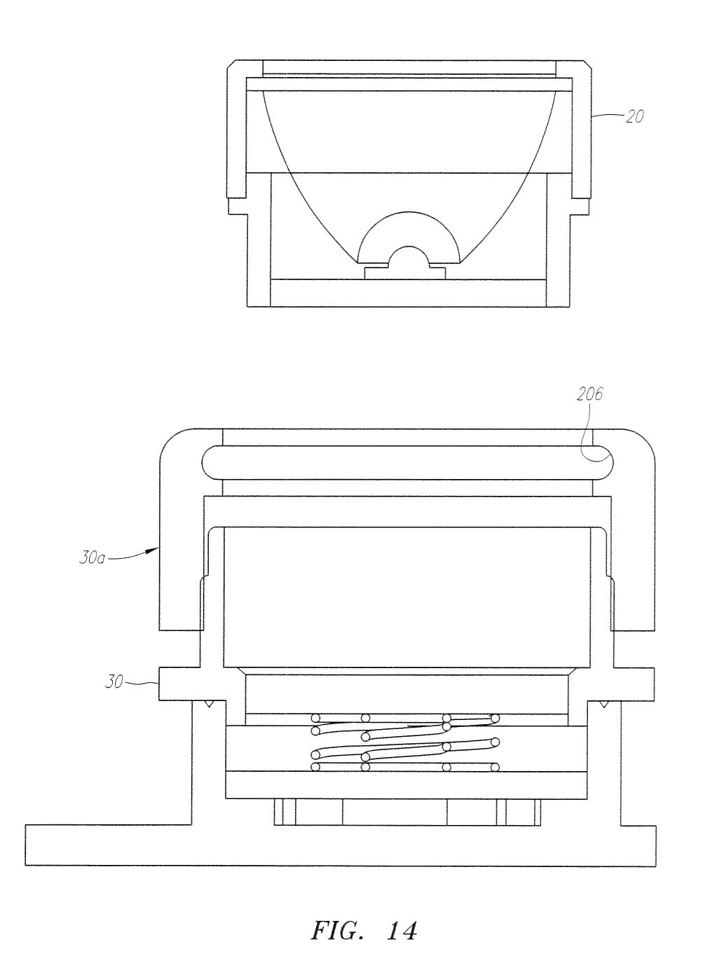

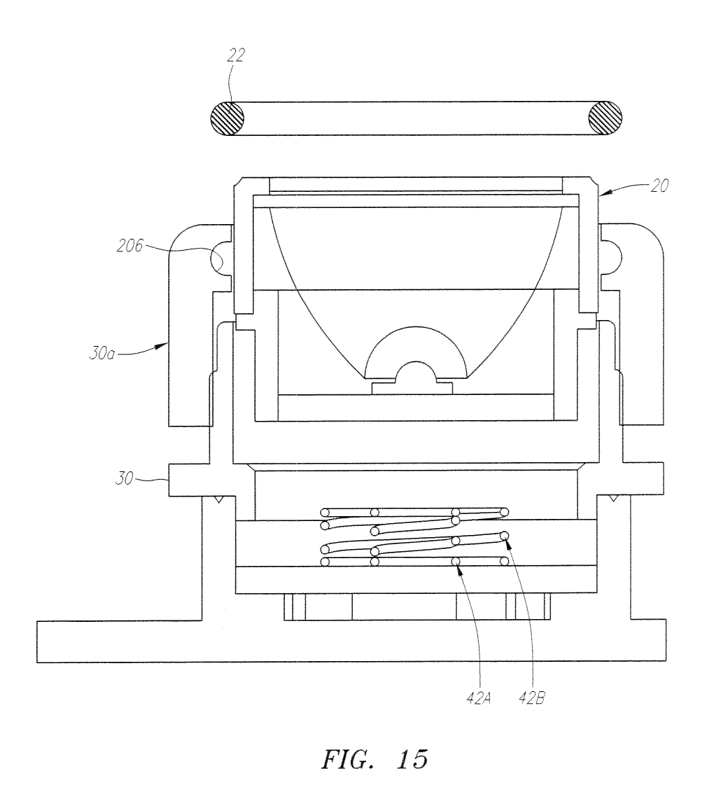

FIG. 14 shows the LED assembly 20 and the LED holder 30 and outside holder 30a positioned above one another in axial alignment just prior to installing of the LED assembly 20 into the LED holder 30 (without using the flexible O-ring as yet). FIG. 15 shows the LED assembly 20 resting inside the cylindrical bore of the LED housing 30 above the two (2) electrical connection compression springs 42A and 42B. When the LED assembly 20 is manually pushed down below the level of the I.D. groove along the inside top surface of the outside LED holder 30 assembly, the flexible O-ring 22 can then be manually pushed into this I.D. groove before allowing the two (2) compression springs 42A and 42B to push the LED assembly 20 upwards into the inside periphery of the flexible O-ring 22 thereby providing a waterproof seal between the moveable LED assembly 20 and the fixed LED housing 30 and avoiding water intrusion and possible electrical circuit failure. O-ring compression of the present O-ring 22 is provided by the spring force of the two springs, which an be adjusted or selected to provide a desired spring compression.

In the case of 120 VAC powered LED traffic signs that have the option for replaceable LEDs, one example of connecting the LEDs is to connect them together in series. In this case, there should also be a compensation circuit 50 that detects if a series-connected LED burns out so that the burned out LED will be bypassed and then all the remaining LEDs in the series string would continue to operate normally. The compensation circuit can adjust the DC power supply to automatically output a new current supply to match with the new requirements of the series-connected LEDs, with, for example, one burned out LED, to avoid burning out the remaining LEDs with too much voltage and/or too much LED drive current (i.e. mA per LED).

One example of the present method, system, and device makes use of a pulse-width-modulated (PWM) control circuit which converts a source of 120VAC external power into DC voltage and also regulates the voltage and the current supplied to the one or more LEDs so that they operate properly. As previously mentioned, if the voltage or the current supplied to the one or more LEDs is too high or too low, the one or more LEDs can be burned out or the LEDs will not provide sufficient illumination.

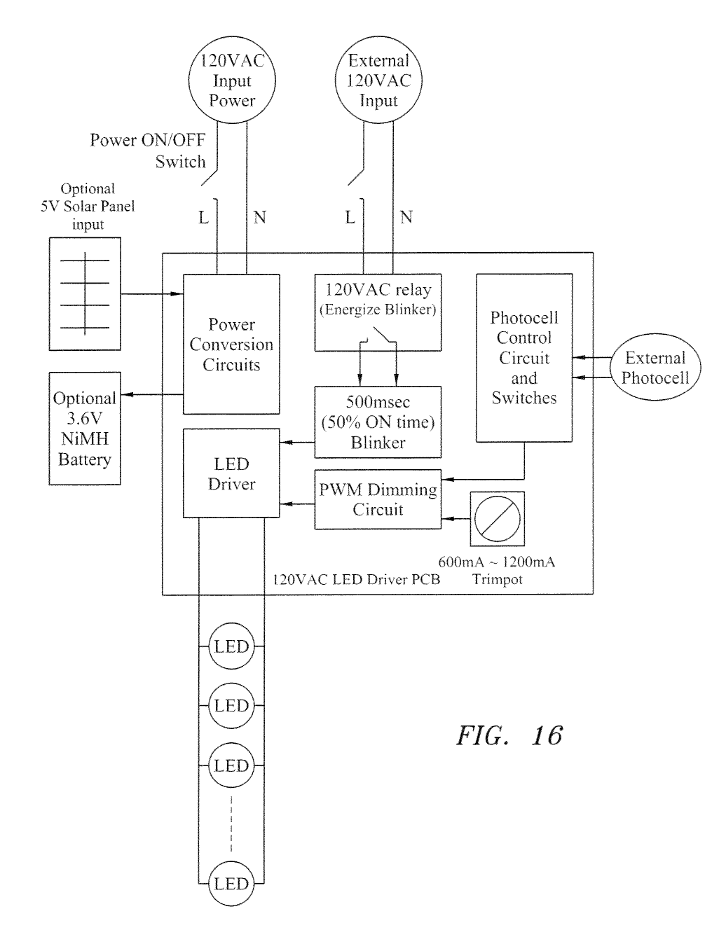

An exemplary block diagram that illustrates this type of PWM Control Circuit is provided in FIG. 16, where various types of input, external 120VAC power, solar panel input power or rechargeable battery power can be used to operate the PWM Control Circuit. A day and night switch control can also be incorporated to operate from an external photocell or other signal input to increase the amount of power consumed by the LEDs in daytime (for increased brightness) and reduce the amount of LED power at night (for decreased brightness). The power conversion circuits provide the DC voltage and current to the control circuit system. The pulse-width-modulating (PWM) circuit is used to automatically adjust the DC voltage and current provided to the one or more LEDs mounted on the traffic sign, and these are supplied with electrical energy from the LED driver circuit. The control circuit can provide intermittent power pulses to the LEDs so they flash or blink, or the LEDs can be provided with a steady power supply so the LEDs remain operating at a constant amount of output light brightness.

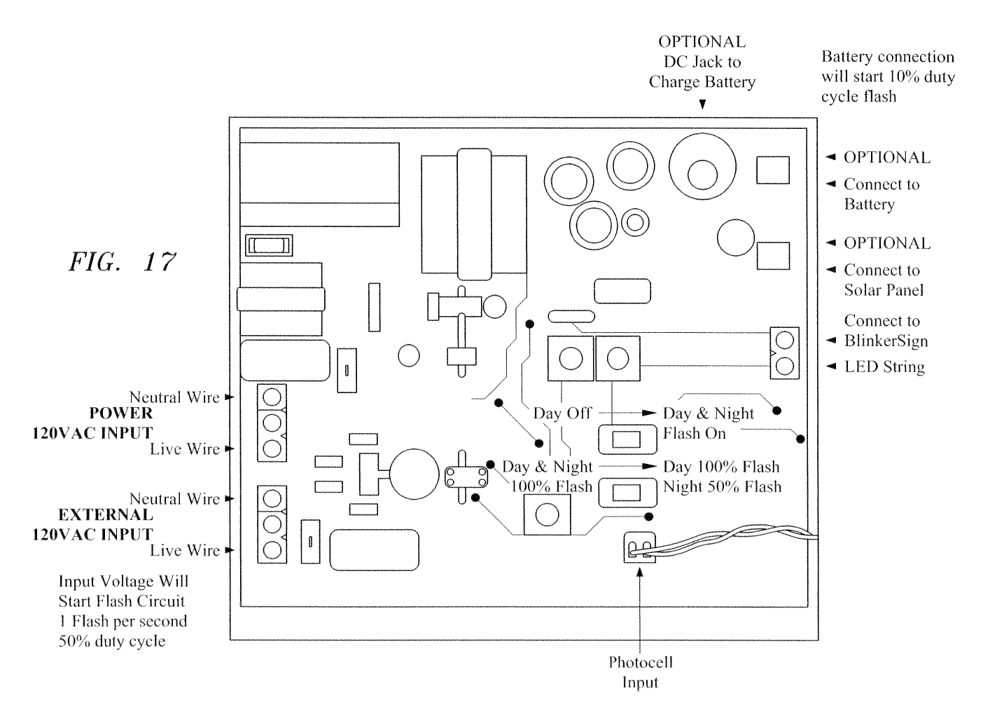

A physical example of this type of PWM control circuit using 120VAC power supply is shown in FIG. 17. It should be noted that this PWM control circuit can be relatively small, with the plan view dimensions of the PCB board about 1.8×2.6 inches. There are some rheostat trim potentiometers as well as switches on this PCB board and these are used for (a) adjusting the sensitivity of the photocell input used for detecting day versus night conditions, (b) adjusting the maximum daytime current supply as well as the minimum night time current supply levels, and (c) adjusting the day and night LED operation for night only flashing, or day flashing at 100% with night flashing at 50%, or day & night both flashing at 100%. Many other types of inputs and adjustment features would be obvious to one skilled in the art.

If the one or more LEDs are connected in series, then a constant current power supply is needed so that the voltage supply can be matched with the requirements of the series-connected LEDs while maintaining the current being supplied per LED at a constant value. For example, if there are eight (8) red-colored LEDs connected in series on a traffic sign, then the required DC supply voltage for the entire series-connected LED string would be about 26.4VDC (i.e. 8 times 3.3VDC). If one of these LEDs fails, then the required supply voltage for the remaining seven (7) series-connected LEDs will immediately decrease to about 23.1VDC (i.e. 7 times 3.3VDC). However, if the PWM control circuit does not automatically decrease the supply voltage from about 26.4VDC to 23.1VDC, then the remaining series-connected LEDs will quickly burn out due to over-current supply and over-heating. Therefore, for series-connected LEDs, the PWM control circuit automatically matches the voltage requirement of the series-connected LED string and maintains the current per LED at a constant value. For different number of LEDs, such as six (6), different voltage value must be accounted for by the control circuit.

If the PWM control circuit using 120VAC power supply is used for parallel connected LEDs, it is not necessary to provide constant current control if the PWM control circuit can automatically adjust the output DC voltage to match exactly with the required forward voltage (Vf) of the one or more parallel-connected LEDs. In the event that one or more of these parallel-connected LEDs stops operating, the current supplied from the PWM control circuit is automatically reduced to the required new value. If one or more of the parallel-connected LEDs stops operating, and if the replacement LED does not have the same forward voltage (Vf) of the remaining LEDs, then the PWM control circuit will provide either too much voltage or too little voltage depending on the Vf value of the replacement LED. To overcome this potential problem when replacing burned our LEDs connected in parallel, in one example, each LED housing contains a small current compensating circuit that acts to adjust the current supply to these parallel-connected LEDs so that they can all operated from the same PWM control circuit supply voltage. Typically, the PWM control circuit supply voltage will be about 4.2V for White LEDs and 3.3V for Red or Amber LEDs.

If the one or more LEDs are connected in parallel, then a Constant Voltage power supply is needed so that the current supply can be matched with the requirements of the parallel-connected LEDs while keeping the voltage supplied per LED at a constant value. For example, if there are eight (8) red-colored LEDs connected in parallel on a traffic sign, then the required DC supply voltage for these parallel-connected LEDs would be about 3.3VDC, and the required current of about 150 mA per LED would total about 1200 mA (i.e. 8 times 150 mA). If one of these LEDs fails, then the required current supply for the remaining seven (7) parallel-connected LEDs will immediately decrease to about 1050 mA (i.e. 7 times 150 mA). However, if the PWM control circuit does not automatically decrease the supply current from about 1200 mA to 1050 mA, then the remaining parallel-connected LEDs will quickly burn out due to over-current supply and over-heating. Therefore, for parallel-connected LEDs, the PWM control circuit automatically matches the current requirement of the parallel-connected LEDs and maintains the voltage per LED at a constant value.

As shown in FIG. 17, the PWM control circuit converts a 120VAC power supply to a DC voltage that provides either constant current supply or constant voltage supply to the one or more traffic sign LEDs. In constant current supply mode, series-connected LEDs are equipped with compensation circuits in their own LED holders that enable all the remaining LEDs to continue operating normally in the event any one of the series-connected LEDs stops operating. For parallel-connected LEDs, a similar compensation circuit 50 is installed inside the LED holder 30 to compensate for differences in the forward voltages (Vf) of the parallel-connected LEDs. In this case, the compensation circuit 50 will be connected in series with the LED to maintain the forward voltage (Vf) at a slightly increased value of DC voltage, which enables all of the parallel-connected LEDs to operate at the same level of current consumption even if they all have different values of forward voltage (Vf). These compensation circuits 50 can be adjusted to operate the parallel-connected LEDs at any desired level of current (such as 150 mA) so that none of the parallel-connected LEDs will ever be over-driven or under-driven. In the event that one of the parallel-connected LEDs burns out, the remaining LEDs will continue to operate properly. The present invention allows series-connected or parallel-connected LEDs to continue operating properly regardless if one or more of the LEDs burns out and regardless if the LEDs are powered from the PWM control circuit or from a battery which is recharged from a solar photovoltaic panel. The only difference might be that the continuous running time for the traffic sign LEDs might be reduced in the case of the solar-powered battery system if the amount of solar charging provided to the battery is not sufficient.

To achieve the best LED performance, both series and parallel connected LEDs require a control circuit in order to automatically adjust the output voltage or the output current to optimum levels that match with the electrical characteristics of the LEDs which are being supplied with power. The preferred type of control circuit uses pulse-width-modulated (PWM) control to provide automatic adjustment. The PWM control circuit using a 120VAC power supply can be configured for constant current or constant voltage operation by means of simple changes to the values of small resistors located on the circuit board. In addition, the LED holder 30 for these LEDs mounted on traffic signs or structures should also contain compensation circuits 50 designed for either series-connected or parallel-connected wiring configurations for the LED holders 30. In this way, the present method, system, and device allow for easy replacement of traffic sign LEDs using the LED assembly 20 configuration, without requiring the LED traffic sign to be removed from the mounting structure and without requiring the maintenance personnel to know the forward voltage (Vt) or the wiring connection of the LED holder 30 only the color of the replacement LED. While not necessary, nothing disclosed herein limits the ability of a technician to remove and take a traffic sign back to a shop for replacing a burned out LED light.

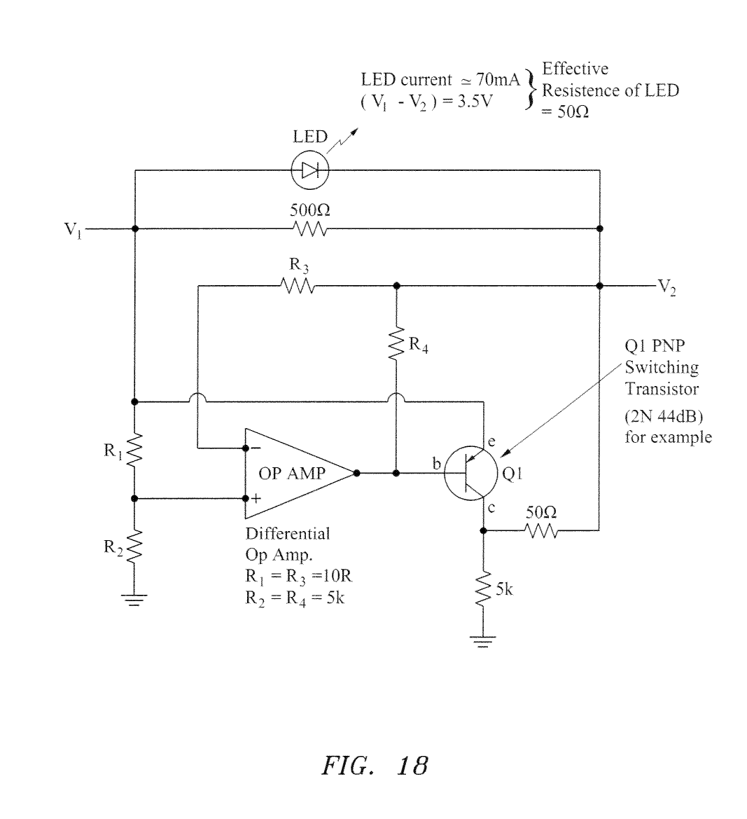

One preferred embodiment of a compensation circuit 50 for series-connected LEDs makes use of an operational amplifier to detect when the series-connected LED has burned out, and then compensates by diverting the series-connected voltage supply around the burned out LED so that the LEDs remaining in the series-connected string continue to operate normally. One example of this type of operational amplifier compensation circuit 50 is shown in FIG. 18. As shown in this figure, when the LED is working normally, the 500 ohm bypass resistor causes a small LED current boost from about 70 mA to about 77 mA. The operational amplifier (Op Amp) is provided with a high value of voltage difference between V1 and V2. The base of PNP transistor Q1 goes high, thereby turning off Q1 so that the emitter and collector across Q1 are disconnected and the LED continues to operate normally. However, if the LED fails, then the current through the 500 ohm bypass resistor decreases substantially. The Op Amp is provided with a low value of voltage difference between V1 and V2 and this causes the base of PNP transistor Q1 to go low thereby turning on Q1 so that the emitter and collector across Q1 are connected, and V1 is thereby connected to V2 through Q1. The failed LED has been successfully bypassed and the remaining series-connected LEDs continue to operate normally.

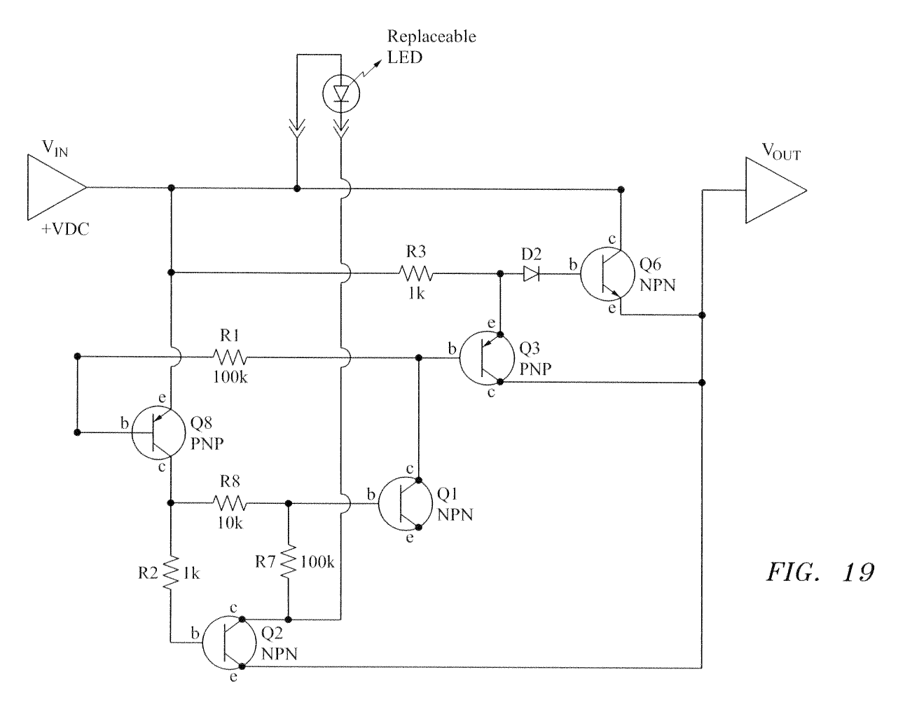

In one example, it is possible to delete the operational amplifier since these generally require about 1.5VDC additional voltage above the LED operating voltage for proper operation, and it is more expensive to use operational amplifiers which can work properly below about 3.0VDC. An improved type of compensation circuit 50 is shown in FIG. 19, which requires only ten (10) surface-mounted circuit components, which are sufficiently small that the compensation circuit 50 can easily fit inside the previously described LED holder 30.

The improved compensation circuit 50 is shown in FIG. 19 where there are both NPN and PNP transistors. The NPN transistors turn on and connect the emitter and collector whenever the base voltage is sufficiently high. Conversely, the PNP transistor turn off any connection between emitter and collector if the base voltage is sufficiently high (more than about 0.7 VDC). If the base voltages are sufficiently low (less than about 0.2 VDC), then the NPN transistors turn off and the PNP transistors turn on the connections between emitter and collector. By using both NPN and PNP transistors, various switching combinations can be configured.

The heart of the improved compensation circuit 50 in FIG. 19 is the electronic latch comprised by resistors R7, R8 and R1, as well as transistors Q8-PNP and Q1-NPN. During normal operation, the series-connected LED is forward biased to supply a tiny current to Q1-NPN. Q1-NPN turns on and supplies its collector output through resistor R1 and dropping the voltage supplied to the base of Q8-PNP, and this causes transistor Q8-PNP to then latches on. Q8-PNP then supplies a drive current to Q2-NPN that turns on the LED. Q2-NPN has extremely low turn-on voltage of about 50 mV to 60 mV, so there is very little power lost. This latching process happens very quickly. The collector output from transistor Q1-NPN is sufficiently high to turn off transistor Q3-PNP so the LED is not bypassed in normal mode operation. In the event that the series-connected LED fails, then there will be no current flowing through resistor R7 so the latch circuit will not be triggered and Q2-NPN remains turned off. At the same time, resistor R3 and diode D2 supply a suitable base voltage to transistor Q6-NPN, which is the bypass switch. The diode D2 increases the turn on voltage of transistor Q6-NPN, increasing it to about 1.4VDC, so that Q6-NPN will not be turned on all the time. Transistor Q3-PNP is a voltage buffer with reverse biased base-emitter configuration that prevents any tiny current from Q8-PNP and resistor R1 from triggering the Q6-NPN bypass switch. Transistor Q6-NPN is then turned on and causes Vin to be directly connected to Vout, thereby bypassing the failed series-connected LED. This improved compensation circuit 50 consumes less than about 2 mA to maintain the latch system during normal operation.

It should be noted that this same compensation circuit 50 in FIG. 19 can also be installed into any of the disclosed LED holders 30, which are wired for parallel-connected LEDs on traffic signs. In this case, the compensation circuit 50 will be connected in series with the traffic sign LED to maintain the forward voltage (Vf) at a slightly increased value of DC voltage, which enables all of the parallel-connected LEDs to operate at the same level of current consumption even if they all have different values of forward voltage (Vf). The LED assembly 20 would receive its positive input DC voltage from one of the two (2) parallel wire connections, and the output from the improved compensation circuit 50 would be connected to the other wire which represents the negative DC voltage output. With the LED assembly 20 working properly, the compensation circuit 50 simply latches as before and connects electrical power through the LED by turning on transistor Q2-NPN. If the parallel-connected LED fails, then the compensation circuit 50 turns off Q2-NPN and as before, the Q5-NPN bypass switch is turned on to bypass the failed LED. The compensation circuit 50 can be adjusted to operate the parallel-connected LEDs at any desired level of current (such as 150 mA) so that none of the parallel-connected LEDs will ever be over-driven or under-driven.

The present method, system, and device provide that LED assemblies 20 having the same color light output which are installed into the LED holders 30 mounted on the traffic sign appear to operate at the same overall light output brightness level, regardless of the forward voltage (Vf) rating of the LEDs or the source of the electric power supply. The equality of the apparent LED light output brightness levels for the traffic sign LEDs can be produced based on power supplied from external power sources (120VAC or 240VAC) or from a rechargeable battery which may be recharged using solar photovoltaic panels, external power sources, or chemical additives.

As previously discussed, the present method, system, and device make use of small compensation circuits added inside each LED holder so that any type of LED traffic sign can operate reliably regardless if one or more of the LEDs has burned out. In addition, the present method, system, and device allow for the traffic sign LEDs to be connected in series, or in parallel, or in a combination of series and parallel. These traffic sign LEDs can have different forward voltage (Vf) values, and despite this, the use of these compensation circuits allow for the light output brightness levels of the LEDs to appear the same. This equality of LED brightness remains consistent regardless if the LEDs are powered from external electricity sources or from solar panels and rechargeable batteries.

By installing the small compensation circuits inside each of the LED holders, any type of LED traffic sign can operate reliably regardless if one or more of the LEDs burned out. If any particular LED mounted on a traffic sign happens to fail, it can be replaced with the same color LED without the maintenance personnel having to worry about the forward voltage (Vf) value of the LED. Also, the maintenance personnel can replace the same color of LED into a series-connected LED holder socket or a parallel-connected LED holder socket without knowing which type of socket connection wiring has been used for the specific LED traffic sign. Regardless of which type of socket wiring connection has been used, the present invention allows the replaced LED to work perfectly and match with the apparent brightness of all the other LEDs which have not yet burned out.

The present methods, systems, and devices may be practiced a number of different ways, including in the following described examples:

Easy Replacement of Failed LEDs on LED Traffic Signs: In the event that one or more of the LEDs on an LED traffic sign fail to operate properly, the control circuit and the individual compensation circuits installed in each LED holder allow all the remaining LEDs on the LED traffic sign to continue operating properly. In one example, such failed LED can easily be removed and replaced on an LED traffic sign using only hand operated tools in situ with access from ladders or other similar equipment and using only normal highway maintenance procedures. It is preferred that the replacement LED should only provide the same color of LED light as the original LEDs on the traffic sign, and that variations in forward voltage (Vf) or variations in electrical connections between LEDs (i.e. series-versus parallel-versus a combination of both series- and parallel-connected LEDs) do not change the proper operation of the LED traffic sign with all the LEDs appearing to provide about the same brightness of light intensity output. In addition, it is preferred that the combination of the control circuit with the compensation circuits with the individual LEDs can be adapted to a variety of electrical power sources including solar panels used for recharging a battery power supply, or external sources of electrical power such as 120VAC or 240VAC. Also, it is preferred that normally operating LEDs on the LED traffic sign do not need to be turned off when any one or more failed LEDs are being replaced using only hand operated tools and normal highway maintenance procedures.

Solar Powered LED Traffic Sign: In another example, an LED traffic sign powered from a rechargeable battery and recharged each day using solar energy derived from a solar photovoltaic panel is used. There are a variety of options for the control circuit which is used to provide electrical power from the battery to the one or more LEDs on the traffic sign. For example, one method utilizes flashing LEDs to provide enhanced visibility of the traffic sign by oncoming traffic, with the LEDs flashing about one time per second. Due to the higher ambient light conditions during daylight hours, it is preferred that the flashing of the LEDs is brighter during daylight hours and then reduced during night time hours. For example, one method of control for an LED traffic sign having eight (8) separate LEDs mounted along the periphery of the traffic sign might be to provide 150 mA per LED (total of 1200 mA current during the flash cycle) during daytime and 75 mA per LED (total of 600 mA current during the flash cycle) during the night hours. The transition from day and night and vice versa is preferably detected using a suitable photocell sensor input to the control circuit. The solar panel used for recharging the battery can be provided in different configurations. For example, if the LEDs are electrically connected to operate in parallel, then the rechargeable battery can preferably be rated 4.8VDC and the solar panel can be rated preferably at about 7.5VDC to insure adequate solar recharging in overcast weather conditions. Another example is provided if the LEDs are electrically connected to operate in series, then with 8 pcs of red-colored LEDs, the rechargeable battery can preferably be about 36VDC (or a small value if DC voltage converter circuits are used in the control circuit) and the solar panel can be rated preferable about 50% higher than the battery voltage rating to insure adequate solar charging during inclement weather conditions.

LED Traffic Sign Powered from 120VAC External Source: Another example is an LED traffic sign which is powered from an external 120VAC power source. As with the solar powered LED traffic sign, there are a variety of options for the control circuit which is used to provide electrical power to the one or more LEDs on the traffic sign. For example, one method utilizes flashing LEDs to provide enhanced visibility of the traffic sign by oncoming traffic, with the LEDs flashing about one time per second. Due to the higher ambient light conditions during daylight hours, it is preferred that the flashing of the LEDs is brighter during daylight hours and then reduced during night time hours. For example, one method of control for an LED traffic sign having eight (8) separate LEDs mounted along the periphery of the traffic sign might be to provide 150 mA per LED (total of 1200 mA current during the flash cycle) during daytime and 75 mA per LED (total of 600 mA current during the flash cycle) during the night hours. The transition from day and night and vice versa is preferably detected using a suitable photocell sensor input to the control circuit. If the LEDs are electrically connected to operate in parallel, then it is preferable that the control circuit provides DC power at about 3.3VDC for red or yellow colored LEDs and about 4.5VDC for white-colored LEDs. If the LEDs are electrically connected to operate in series, then with 8 pcs of red-colored LEDs, the control circuit would provide about 26.4VDC to the series string of LEDs (i.e. 8 times 3.3VDC equals 26.4 VDC). It is preferred that the control circuit automatically compensates if one or more of the LEDs fails to operate, thereby requiring that the DC voltage or the DC current be adjusted so the remaining LEDs will not be over-driven (thereby causing early burn out failure) or under-driven (thereby causing insufficient LED light output brightness). Also, it is preferred that the control circuit automatically re-adjusts the DC voltage or the DC current when any one or more failed LED are replaced by highway maintenance personnel, with the result that the operational LEDs on the LED traffic sign continue to operate normally both before and after the LED replacement process.

Although limited embodiments of lighting sub-assemblies and control circuits and their components for powering LED lights in parallel, in series, or in both parallel and series have been specifically described and illustrated herein, many modifications and variations will be apparent to those skilled in the art. Accordingly, it is to be understood that the lighting sub-assemblies and control circuits constructed according to principles of the present device, system, and method may be embodied other than as specifically described herein. The invention is also defined, at least in part, in the following claims.

What is claimed is:

1. An enhanced visibility traffic sign comprising:
a sign structure comprising at least two replaceable LED assemblies each installed in an LED holder mounted on the sign structure; each LED assembly being sealed with a water-tight seal to the LED holder; and wherein
A. a compensation circuit is installed in each LED holder and in electrical communication with the LED assembly installed to the LED holder; the compensation circuit is configured to cause any failed LED to be electrically bypassed to allow any remaining operating LED assembly on the traffic sign structure to continue operating, and
B. the failed LED assembly on the traffic sign structure can be removed and replaced in situ with another LED assembly having an acceptably similar color and LED light output.

2. The traffic sign according to claim 1, wherein the electrical communication between the LED assembly and the compensation circuit is accomplished using a spring.

3. The traffic sign according to claim 1, wherein the water tight seal is accomplished using at least one flexible O-ring or a flexible gasket located between the LED assembly and the LED holder.

4. The traffic sign according to claim 3, wherein the flexible O-ring or the flexible gasket is compressed by means of a spring acting on the LED assembly to force it to provide adequate compression on the flexible O-ring or the flexible gasket.

5. The traffic sign according to claim 3, wherein the flexible O-ring or the flexible gasket is compressed between an outside wall surface of the LED assembly and an inside wall surface of the LED holder.

6. The traffic sign according to claim 1, wherein electrical power for proper operation of the at least two LED assemblies is provided by a suitable control circuit which can provide either constant current or constant voltage to the at least two LED assemblies to automatically adjust either the output voltage or the output current to avoid over-driving or under-driving the at least two LED assemblies.

7. The traffic sign according to claim 1, wherein electrical power for proper operation of the at least two LED assemblies is provided from a rechargeable battery or from an external source of electric power.

8. The traffic sign according to claim 7, wherein the rechargeable battery may be recharged by one or more solar photovoltaic panels, by external source of electric power, or by chemicals which are added into a fuel cell system; and wherein the operating voltage is 120VAC or 240VAC.

9. The traffic sign according to claim 1, wherein the compensation circuit is designed to (a) provide an electrical bypass around a failed LED assembly while enabling any remaining LED assembly to continue operating properly, and (b) be compatible with various differences in electrical wiring connections between LED holders which provide electric power to the LED assemblies, such as series-connected, parallel-connected, or a combination of both series- and parallel-connected electrical wiring configurations.

10. The traffic sign according to claim 1, wherein the compensation circuit comprises surface-mounted circuit board components that can be installed inside the LED holder.

11. The traffic sign according to claim 1, wherein each LED assembly is rotatable relative to the LED holder that the LED assembly is located in to align an output light beam angle provided by the LED assembly.

12. The traffic sign according to claim 11, wherein the LED assembly is rotatable by engaging a tab on the LED assembly with an adjustment click groove located within the LED holder.

13. The traffic sign according to claim 1, wherein an output light beam angle provided by each LED assembly is controlled by a selected LED collimating lens.

14. The traffic sign according to claim 1, wherein a control circuit in combination with the compensation circuit automatically adjusts an electrical power supply to any remaining LED assembly on the traffic sign when at least one LED assembly ceases to operate.

15. The traffic sign according to claim 14, wherein the control circuit in combination with the compensation circuit automatically bypasses any failed LED assembly and automatically adjusts a voltage or a current being supplied to any remaining LED assembly for continued operation.

16. The traffic sign according to claim 14, wherein the control circuit in combination with the compensation circuit maintains proper operation of any remaining LED assembly regardless of electrical connections between LED holders being series-connected, parallel-connected, or both series- and parallel-connected.

17. The traffic sign according to claim 1, wherein a control circuit in combination with the compensation circuit allows for operation of the at least two LED assemblies on the traffic sign regardless of a source of electrical power supply, which can be derived from a rechargeable battery, an external source of electrical power, or from a fuel cell system.

18. The traffic sign according to claim 1, wherein a control circuit in combination with the compensation circuit allows for operation of the at least two LED assemblies on the traffic sign regardless whether the LED holders are series-connected, parallel-connected, or both series- and parallel-connected with electrical power supply.

19. The traffic sign according to claim 1, wherein a control circuit in combination with the compensation circuit allows for operation of the at least two LED assemblies on the traffic sign powered from a rechargeable battery which is recharged either with one or more solar photovoltaic panels, with an external source of electric power, with a fuel cell system, or any combinations thereof.

20. The traffic sign according to claim 1, wherein any failed LED assembly can be replaced with another LED assembly having acceptably similar LED light output color, regardless of forward voltage (Vf) rating of the replacement LED or type of electrical wiring connection provided to the corresponding LED holder.

21. The traffic sign according to claim 1 wherein the at least two LED assemblies are aimed towards oncoming traffic to provide enhanced visibility of the traffic sign.

22. The traffic sign according to claim 1, wherein the at least two LED assemblies are aimed toward oncoming traffic by means of placement of the LED housings at spaced apart locations on the traffic sign.

23. The traffic sign according to claim 1, wherein the at least two LED assemblies are aimed by means of placement of the LED housings to provide reflected LED output light which causes at least one of the traffic sign faces to be illuminated.

24. The traffic sign according to claim 1, wherein a control circuit is capable of automatically adjusting DC output voltage or DC output current being supplied to the at least two LED assemblies using pulse-width-modulation (PWM) methods for such automatic adjustment so as not to over-drive or under-drive the traffic sign LED assemblies.

25. An enhanced visibility traffic sign comprising one or more LED assemblies aimed towards oncoming motor vehicle traffic, wherein the one or more LED assemblies make reliable electrical connections with one or more LED holders installed in various locations on the traffic sign, and wherein the one or more LED assemblies operate by a control circuit which supplies direct current at suitable levels of DC voltage and DC current to one or more LED holders, wherein the one or more LED holders also include compensation circuits which enable any failed LED assembly to be electrically bypassed in which case the control circuit then automatically adjusts the DC current or DC voltage levels supplied to the remaining traffic sign LEDs so that the remaining LED assemblies continue to operate properly.

26. The traffic sign according to claim 25, wherein the one or more LED assemblies are suitable for in situ repair or replacement which can be provided by normal highway maintenance personnel using only hand operated tools.

27. The traffic sign according to claim 25, wherein the one or more LED holders are connected together using series, parallel or a combination of both series and parallel wiring connections in order to provide electrical power to one or more LED housings, which provide electrical power to the one or more LED assemblies installed therein.

28. An enhanced visibility traffic sign comprising one or more LED assemblies aimed towards oncoming motor vehicle traffic, wherein the one or more LED assemblies are replaceable from one or more LED holders using only hand operated tools, wherein the one or more LED assemblies make reliable electrical connections with the one or more LED holders, which are installed in various locations as desired on the traffic sign, and wherein the one or more LED assemblies operate by means of a control circuit which supplies direct current at suitable levels of DC voltage and DC current to the one or more LED holders.

29. The traffic sign according to claim 28, wherein each of the one or more LED holders contain compensation circuits, and in the event that one or more of the LED assemblies fails to operate properly, these compensation circuits enable all the remaining LED assemblies to continue to operate properly regardless if the LED holders are connected in series, in parallel, or in a combination of both series and parallel wiring connections.

30. The traffic sign according to claim 28, wherein the one or more LED assemblies are suitable for in situ removal and replacement which can be provided by normal highway maintenance personnel using only hand operated tools.

31. The traffic according to claim 28, wherein the one or more LED assemblies include collimating lenses used to provide a desired LED output light beam angle.

32. The traffic sign according to claim 31, wherein the output light beam angle is 20 degrees, 30 degrees, 40 degrees or any combination thereof.

33. A lighting sub-assembly comprising:
an LED holder having a cavity;
an LED assembly positioned in the cavity in a water-tight seal with a housing of the LED holder;
a circuit board located inside the housing and below the LED assembly;
at least one coil spring located between the circuit board and the LED assembly for electrically coupling the circuit board and the LED assembly; and
wherein the LED assembly is rotatable relative to the housing to change a light beam spread orientation of light emitted from the lighting sub-assembly.
